(19) United States
(12) Patent Application Publication
(10) Pub. No.: US 2012/0084281 A1
(43) Pub. Date: Apr. 5, 2012

(54) DOMAIN NAME TOKENIZATION AND ALTERNATIVE DOMAIN NAME GENERATION

(75) Inventor: John COLOSI, Dulles, VA (US)

(73) Assignee: VeriSign, Inc.

(21) Appl. No.: 13/249,429

(22) Filed: Sep. 30, 2011

Related U.S. Application Data
(60) Provisional application No. 61/388,395, filed on Sep. 30, 2010.

(51) Int. Cl. G06F 17/30

(52) U.S. Cl. 707/723; 707/767; 707/E17.014

(57) ABSTRACT

A system for determining alternative domain names is disclosed. The system includes a receiver that receives input from a user and a synonym module that determines synonyms of at least one word in the user input. The system also includes a correlation module that receives the synonyms from the synonym module and terms from a topical news source database and generates a correlation score for at least one of the terms from the topical news source database based on a correlation between the term from the topical news source database and the user input. The system also includes a variants module that generates an alternative domain name based on the term from the topical news source database and its correlation score.

This application claims priority to U.S. Provisional Application No. 61/388,395, filed on Sep. 30, 2010, the disclosure of which is incorporated herein by reference in its entirety.

### TECHNICAL FIELD

This application is related to domain names and, in particular, systems and methods for determining alternatives to a requested domain name.

### BACKGROUND

The Internet enables a user of a client computer system to identify and communicate with millions of other computer systems located around the world. A client computer system may identify each of these other computer systems using a unique numeric identifier for that computer called an Internet Protocol (“IP”) address. When a communication is sent from a client computer system to a destination computer system, the client computer system may specify the IP address of the destination computer system in order to facilitate the routing of the communication to the destination computer system. For example, when a request for a website is sent from a browser to a web server over the Internet, the browser may ultimately address the request to the IP address of the server. IP addresses may be a series of numbers separated by periods and may be hard for users to remember.

The Domain Name System (DNS) has been developed to make it easier for users to remember the addresses of computers on the Internet. DNS resolves a unique alphanumeric domain name that is associated with a destination computer into the IP address for that computer. Thus, a user who wants to visit the Verisign website need only remember the domain name “versign.com” rather than having to remember the Verisign web server IP address, such as 65.205.249.60.

A new domain name may be registered by a user through a domain name registrar. The user may submit to the registrar a request that specifies the desired domain name. The registrar may consult a central registry that maintains an authoritative database of registered domain names to determine if a domain name requested by a user is available for registration, or if it has been registered by another. If the domain name has not been registered, the registrar may indicate to the user that the requested domain is available for registration. The user may submit registration information and a registration request to the registrar, which may cause the domain to be registered for the user at the registry. If the domain is already registered, the registrar may inform the user that the domain is not available.

Many domain names have already been registered and are no longer available. Thus, a user may have to submit several domain name registration requests before finding a domain name that is available. There may be suitable alternative domain names that are unregistered and available, although a user may be unaware that they exist. An effective system is needed for proposing suitable, unregistered alternative domains that are available for registration, based on a requested domain that may be unavailable or upon a term or phrase submitted by a user. Such a system may propose alternative domain names that are appealing to the user and that are responsive to the user's needs.

### SUMMARY

Disclosed embodiments provide mechanisms for selecting and presenting to the user alternative domain names based on a requested domain name that is already registered or based on a term or phrase submitted by a user. Various criteria can be applied to select the alternative domain names. In certain embodiments, the requested domain name is analyzed in view of news content. Alternatives that are related to the requested name and that are relevant to news content from present day or past events are selected and presented to the user. Other criteria that can be applied include selecting alternatives from a list of NXD domains, which are unregistered domain names for which resolution requests have been received. Yet other criteria can relate to the price paid for keywords, such as Adwords sold for the Google search engine.

Systems consistent with disclosed embodiments include a receiver that receives input from a user and a synonym module that determines synonyms of at least one word in the user input. The systems may also include a correlation module that receives the synonyms from the synonym module and terms from a topical news source database and generates a correlation score for at least one of the terms from the topical news source database based on a correlation between the term from the topical news source database and the user input. The systems may also include a variants module that generates an alternative domain name based on the term from the topical news source database and its correlation score.

Systems and methods consistent with certain embodiments receive user input, extract terms from topical news content, and determine a correlation score from an extracted term based on the similarity of the extracted term to the user input and the popularity of the extracted term in the topical news content. Disclosed systems and methods also generate an alternative domain name based on the extracted term if the correlation score is above a threshold.

Systems and methods consistent with other embodiments receive user input and generate a plurality of alternative domain names based upon the user input, each alternative domain including a variant, synonym, combination of tokenized components, or a combination thereof of the user input. Disclosed systems and methods also assign a rank to each generated alternative domain name based upon a correlation score of the alternative domain name, a price of the alternative domain name in an online advertisement sales system, or a combination thereof; and provide at least one of the plurality of alternative domain names to a user.

Systems and methods consistent with still other embodiments receive a request to register a domain from a user, the request including a desired domain name term, and determine that the desired domain name is not available for registration. Disclosed systems and methods also generate a plurality of alternative domain names based on the desired domain name term and at least one of: a term obtained from a topical news content source; a tokenized component of a term obtained from a topical news content source; a combination of tokenized components of a term obtained from a topical news content source and the desired domain name term; or any combination thereof. Disclosed systems and methods also present at least one of the plurality of alternative domain names to the user.

Additional objects and advantages of disclosed embodiments will be set forth in part in the description that follows, and in part will be obvious from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosed embodiments. In the drawings:

FIG. 1 is a diagram illustrating an exemplary domain name generation system, consistent with certain disclosed embodiments;

FIG. 2 is a diagram illustrating an exemplary alternatives generator, consistent with certain disclosed embodiments;

FIG. 3 is a flow diagram of a process for generating domain names, consistent with certain disclosed embodiments;

FIG. 4 is a flow diagram of a process for generating domain names, consistent with certain disclosed embodiments;

FIG. 5 is an exemplary interface for a domain name generation system, consistent with certain disclosed embodiments; and

FIG. 6 is an exemplary interface for a domain name generation system, consistent with certain disclosed embodiments.

### DESCRIPTION OF THE EMBODIMENTS

In accordance with certain embodiments, a user may be provided with one or more alternative domain names to a domain name that is desired by the user or based on a term or phrase provided by the user. For example, alternative domain names may be provided when a name desired by the user is unavailable for registration, such as where it has already been registered. A user may be a registrar, a registry, a natural person seeking to register a domain name, an automated process, or any other suitable entity.

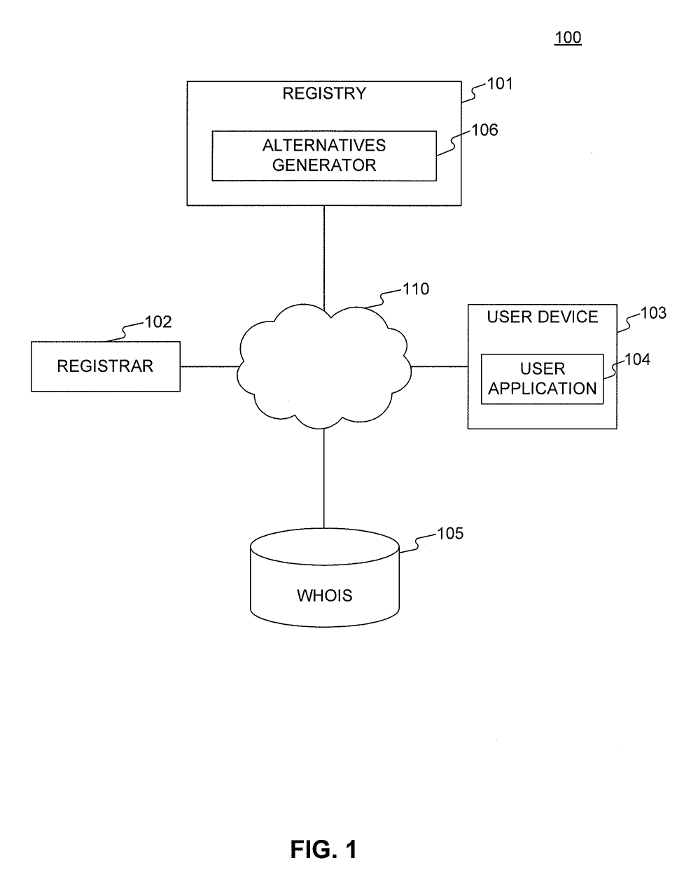

A system 100 consistent with certain disclosed embodiments is shown in FIG. 1. System 100 may include a domain name registry 101 including an alternatives generator 106, a domain name registrar 102, a user device 103 including a user application 104, and a whois database 105 communicatively connected via a network 110. Network 110 may include one or more direct communication links, local area networks (LANs), wide area networks (WANs), or any other suitable connections. Network 115 may also include the Internet.

Alternatives generator 106 may be one or more applications implemented on a device including one or more processors coupled to memory (not shown). The processors may include, e.g., a general purpose microprocessor such as the Pentium processor manufactured by Intel Corporation of Santa Clara, Calif.; an application specific integrated circuit that embodies at least part of the method in accordance with certain embodiments in its hardware and firmware; a mobile device processor, a combination thereof; etc. The memory may be any device capable of storing electronic information, such as RAM, flash memory, a hard disk, an internal or external database, etc. The memory can store instructions adapted to be executed by the processor to perform at least part of the method in accordance with certain embodiments. For example, the memory can store computer software instructions adapted to be executed on the processor to receive user input and generate and output alternatives. The memory can also store data such as topical news content, NXD content, advertising pricing information, stored procedures, etc. The memory can be tamper resistant to help prevent the unauthorized disclosure or modification of sensitive information.

In the embodiment shown in FIG. 1, alternatives generator 106 is provided by registry 101. In other embodiments, the alternatives generator 106 may be provided by the registrar 102 or a third party. In still other embodiments, alternatives generator 106 may be located on user device 103 or may be stored on another server or computer (not shown) connected to network 110.

User device 103 may be a laptop or desktop computer, a smartphone, a tablet or any other suitable device. User application 104 may include a software application that executes on user device 103 and may be controlled by a user, such as a natural person seeking to register or check the availability of a domain name. The user may provide user input, which may include, e.g., a requested domain name or a term or phrase, to user device 103. User application 104 may send a message based on the user input to registrar 102. For example, the message may request registrar 102 to register or check the availability of a requested domain name for registration or may request registrar 102 to suggest one or more domain names based on a term or phrase. Registrar 102 may send a query to whois database 105 or registry 101 to determine if a requested domain name is already registered. Based on the term or phrase, and/or if it is determined that the requested domain name is unavailable, alternatives generator 106 may generate alternatives, query the whois database 105 or registry 101 to determine which of the generated alternatives are available for registration, and send the alternatives that are available to user application 104 or any other suitable destination.

In accordance with certain disclosed embodiments, alternatives generator 106 may use user input as a basis for a topical, context-based search for alternative domain names. For example, alternatives generator 106 may use the user input as a basis for querying various news sources to find related and/or commonly used terms and phrases in recently-published news articles. The terms and phrases identified by alternatives generator 106 can change based upon the changing content of the news. For example, if a requester submits the name “healthcare.com,” alternatives generator 106 may construct queries of online news sources using search terms such as “healthcare” and “health care.” If the search were run against news sources from the year 2003, the following results may be extracted from contemporaneous news sources:

medicare

medicare modernization act

mma

prescription drugs

medicare advantage

The above results may have been returned because the 2003 legislative overhaul to Medicare was one of the leading changes to healthcare in the United States and generated a substantial amount of press coverage.

If the same search were run for new results in 2009, the following results may be extracted from news sources:

reform

single payer

public option

Obamacare

The search results may be processed to create candidate, alternative domain names to the requested name. In certain embodiments, one or more search results may be combined with a Top Level Domain (.com, .net, .tv, .us, etc.) to create an alternative domain name. Similarly, one or more components of the user input may be combined with one or more components of a search result and a top level domain to create an alternative domain name. For example, alternatives based on the 2009 search results may include:

singlepayer.com

healthreform.net

publicoption.com

obamacare.tv

In certain embodiments, alternatives generator 106 may be configured to allow the user to specify the time period in which to search the news content. For example, in some applications the user may specify the time period to be the previous year ending on the present day. Alternatives may be proposed that are relevant to current events and responsive to the user's needs, and thus are more likely to be selected by the user for registration.

In still other embodiments, terms may be combined to shorten alternative domain names, since shorter domain names may easier to use and thus more valuable than longer ones. For example, rather than proposing “healthcarereform.com,” alternatives generator 106 may be configured to detect and eliminate repeating sequences of letters and propose “healthcareform.com.” Thus, one or more letters at the end of one term that are duplicates or are similar to letters at the beginning of another term may be eliminated and the two terms may be combined. For example, “store” and “return” may be combined into “storeturn.” The resulting contraction may be combined with a Top Level Domain (.com, .net, .tv, .us, etc.) to generate an alternative domain name.

Likewise, any term or phrase may be used by alternatives generator 106 to develop alternatives for possible registration as domain names. For example, the user may submit a phrase such as “major weather event.” If the search were submitted in 2002, the results may include:

midwest-drought.us

no-rain.com

dry-midwest.net

If the phrase were submitted in 2005, the results may include:

wettest-october.com

record-rains.com

northeastflooding.net

In accordance with certain disclosed embodiments, system 100 may correlate user input with popular terms in content from news sources. For example, alternatives generator 106 may include a web crawler that searches online news sources for content, identifies common terms and builds lists that ranks terms from highest to lowest number of occurrences within a news source or across news sources. News sources can be targeted by type to establish context around different lists. For example, the term “transgenic” may be a frequently used term in news sources that focus on biotechnology (such as biotechnology scientific and trade publications), but may be relatively rare in news sources that are not specifically aimed at a biotechnology audience. Thus, topics and keywords may be associated with a list of terms based on the subject matter of the news sources. For example, “transgenic” may appear as a common word on a list that is associated with the terms “biotechnology,” “genetics,” “GMO,” etc. A set of related terms may be generated for some or all of the terms on a list and may be correlated with the original term or list. This can be done with a thesaurus or other tool for generating similar terms.

User input and/or other terms, such as terms resulting from news searches or other sources, may be analyzed to generate a set of related terms for the input, e.g., by using a thesaurus or other tools. The input and/or other terms can be tokenized, i.e., broken into their constituent parts, and the resulting tokenized components can, in turn, be used to find or generate related terms, either individually or in combination.

The user input and/or the set of related terms can be compared to the terms, the lists, and/or topics associated with the lists to determine which terms relate to the user input. For example, the alternatives generator 106 may receive user input “genetics” and may generate the following synonyms:

Gene

DNA

transgenic

GMO

Biotechnology

Alternatives generator 106 may detect “biotechnology” as a topic name for a list or set of lists of commonly used terms extracted from news sources. Such a list can be stored at or be accessible to alternatives generator 106. Alternatives generator 106 may focus its search for alternative names on a list or lists with which the topic name, “biotechnology,” is associated. For example, a list of extracted terms from biotechnology news sources may include:

| Topical Term | Number of Occurrences |
|---|---|
| Protein | 368 |
| Nucleus | 83 |
| Clone | 125 |

Further, alternatives generator 106 may generate the following synonyms for each of these extracted terms, e.g., using a thesaurus:

| Topical Term | Synonyms |
|---|---|
| Protein | Amino acid, DNA, building block |
| Nucleus | Cell, genetic material, DNA, transgenic, GMO |
| Clone | Somatic embryogenesis, transgenic, duplicate, gene |

The original user input, “genetics” and its synonyms may then be compared to the extracted terms and their synonyms to determine close correlations. For example, “nucleus” includes three synonyms shared with the user input, “genetics,” while “clone” shares two synonyms and “protein” shares one synonym. The frequency of occurrence of each extracted term may also be taken into account. For example, although “protein” has only one term in common with the user input and its synonyms, “protein” occurs much more frequently in biotechnology news sources than the other terms extracted from the news sources. The popularity and the number of common terms can be weighted and combined for an overall ranking in any suitable way. For example in one embodiment, a score may be assigned to each extracted term according to the following equation:

$$Score = \frac{TermOccurrences}{TotalOccurrences} \cdot Number\_of \_Common \_Synonyms$$

where:

Score is the correlation score for the extracted term on the list to the user input;

TermOccurrences is the number of times the extracted term occurred in the news source or sources;

TotalOccurrences is the total number all of the extracted terms in the list occurred in the news source or sources; and

Number_of_Common_Synonyms is the number of synonyms a extracted term has in common with the user input and its synonyms.

In the above equation, the ratio of TermOccurrences to TotalOccurrences is a measure of the popularity of a term. Other measures can also be used, such as TermOccurrences alone.

Based on the ranking of various extracted terms, alternatives generator 106 may select one or more extracted terms as candidate material for constructing alternatives. Using the example above, alternatives generator 106 may select “nucleus” and “clone” as candidate material for constructing alternatives. Some of the alternatives to “genetics” that may be generated by alternatives generator 106 can include variants and/or combinations of one or more of the user input, “genetics,” the selected extracted terms “nucleus” and “clone,” and/or synonyms thereof. For example, alternatives may include:

User Input: Genetics

Alternatives

Nucleus-DNA

Cell-nucleus

GMO-nucleus

Transgenic

Transgenetics

Transgenesis

Clone

Geneclone

Clonucleus

Aminoprotein

These alternatives may then be combined with a Top Level Domain (.com, .net, .tv, .us, etc.) to create an alternative domain name.

Alternatives generator 106 may use any other processes, such as natural language techniques, to match user input to commonly used terms found in content from new sources. A correlation score may be determined for each term from the news content, and alternative domain names may be selected based upon these scores. For example, terms having a correlation score above a given threshold may be selected as alternative domain names. Further, if an alternative domain name includes multiple terms, a correlation score for the alternative domain name may be calculated based on a sum, average, or other calculation of the correlation scores for the terms making up the alternative domain name. The correlation score may be calculated based on the equation discussed above, or based on any other equation representing a correlation between the user input and one or more terms. In one embodiment, the correlation scores may be normalized to a value between 0 and 1. Terms that are both popular and identified as being most similar to the user input (e.g., by having the greatest number of synonyms in common with the user input) may have correlation scores closer to 1. Terms that are not very common and that are determined not to be highly relevant to the user input (e.g., by having a few or no synonyms in common with the user input synonyms) may have correlation scores that are closer to 0. In one embodiment, alternatives generator 106 may select as alternative domain names all terms that have a correlation score, for example, greater than 0.7. In another embodiment, alternatives generator 106 may select as alternative domain names the ten (or any suitable number) terms having the highest correlation scores.

Another source of candidate domain names may be based on unregistered domain names identified by detecting the number of resolution requests received for such names. Such unregistered names can indicate mistypes of popular, registered names, such as “gppgle.com” for “google.com.” Such names can also indicate properly spelled words and phrases that are descriptive, but not registered, such as “traveltoalbany.com.” A request for an unregistered domain may indicate that the domain is valuable.

Popular requested but unregistered domains (“NXDomains”) may be analyzed by the alternatives generator and categorized. For example:

| NXD Domain | Descriptors | Type |
|---|---|---|
| Gpple.com | google, search engine | Misspelling |
| Traveltoalbany.com | travel, New York, capital | Descriptive |

The alternatives generator 106 can analyze user input in view of the NXDomains on a list and/or the contextual information included as Descriptors or Type information to find which NXDomains are best correlated with the user input. For example, if the user input is newyorktravel.com and this name is already registered, the alternatives generator can tokenize the input into “New York” and “Travel” and match it with “traveltoalbany.com,” which has both of these terms listed as descriptors. The alternatives generator could propose “traveltoalbany.com” as an alternative and identify it as a popular NXD that is already drawing traffic.

In other embodiments, the alternatives generator can select alternatives to user input based on the price paid for synonyms and variants in search engines, such as in Google's Adwords program. In these embodiments, a list of synonyms for user input may be generated. The price for each synonym may be determined from a search engine (such as Google, Bing, etc.) or other advertising services. The relevance of a term on the list can be determined based upon its price. The highest price terms can be proposed as the most valuable alternatives to the user input. Terms throughout the list can be offered as variants or as combinations. For example, for user input “cowboy,” a list of alternatives may be

| Term | Price |
|---|---|
| Texas | $3,200 |
| Steak | $2,540 |
| Cattle | $1,955 |
| Steer | $682 |
| Beefsteak | $429 |
| Lasso | $64 |
| Texas Ranger | $31 |

Based upon this list, the alternatives generator may propose:

Texassteak

Texascattle

Cattlesteak

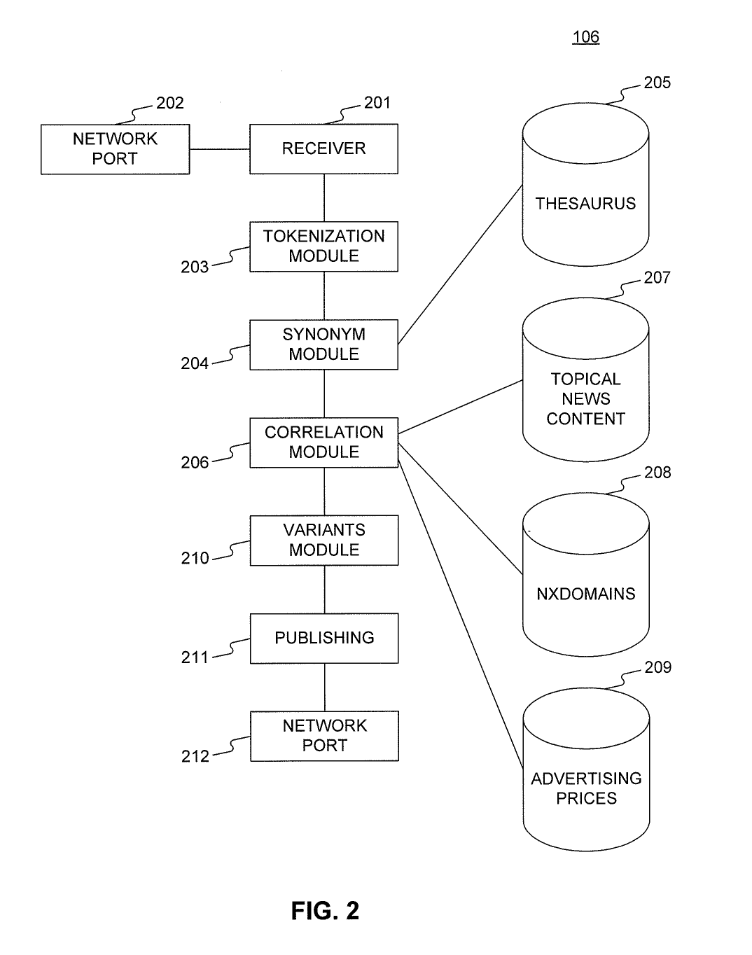

FIG. 2 shows an exemplary block diagram of alternatives generator 106 consistent with disclosed embodiments. In alternatives generator 106, a receiver 201 may receive user input through a network port 202, and may send it to a tokenization module 203. User input may include simple user input, e.g., a single word. User input may also include compound user input, e.g., a compound word or phrase made of more than one word. Tokenization module 203 may parse any compound user input and send the parsed results to a synonym module 204. Synonym module 204 may be in communication with a thesaurus database 205 and may generate synonyms and/or antonyms based on the user input and the contents of thesaurus database 205, sending the results to a correlation module 206. Correlation module 206 may determine relevant alternatives based upon inputs from synonym module 204, a topical news content database 207, an NXDomain database 208 and/or an advertising pricing database 209. Correlated alternatives may be sent from correlation module 206 to variants module 210, which may generate variants based on the correlated alternatives, e.g., plurals, combinations, spelling variants, etc. The resulting set of alternatives may be sent to publisher 211, which may send them to the user or a third party through a network port 212.

While FIG. 2 shows thesaurus database 205, topical news content database 207, NXDomains database 208, and advertising prices database 209 included in alternatives generator 106, these databases may be stored separately and accessed remotely by alternatives generator 106. For example, alternatives generator 106 may access one or more of the databases via network 110, as shown in FIG. 1.

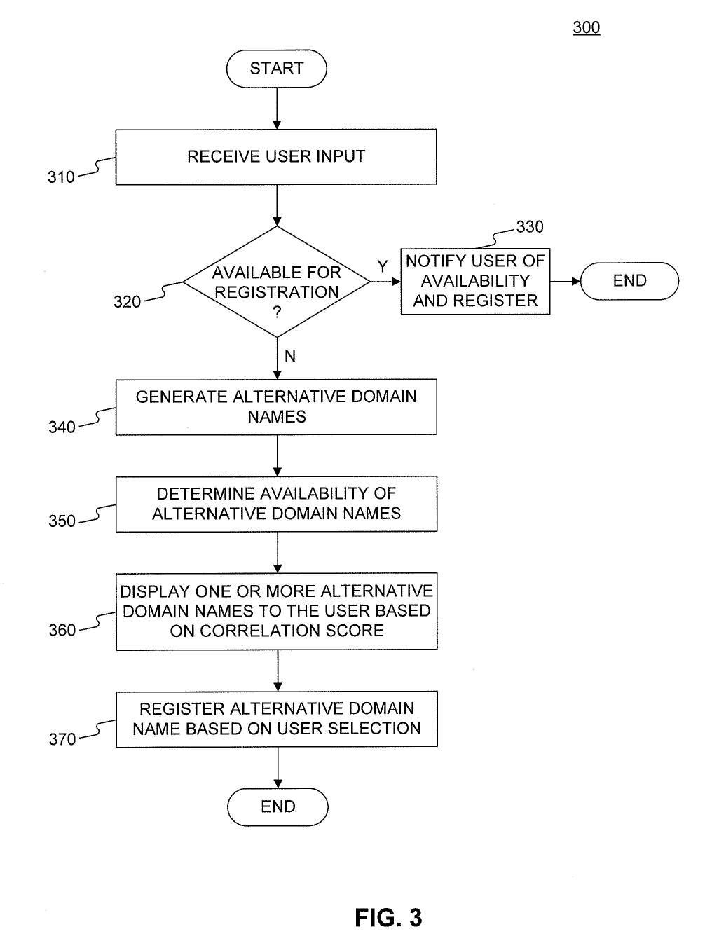

FIG. 3 is a flow diagram of a process 300 for registering domain names, consistent with certain disclosed embodiments. Alternatives generator 106 may perform one or more of the steps included in process 300, for example, upon receiving a request from a user to register a domain name. One or more of the steps included in process 300 may likewise be performed by other components of system 100, e.g., by registrar 102, whois database 105, user device 103, one or more components of registry 101, and/or any combination thereof.

Alternatives generator 106 may receive user input, e.g., via receiver 201 and/or network port 202 (step 310). The user input may include, e.g., a requested domain name and/or a term or phrase provided by a user.

Alternatives generator 106 may determine whether all or part of the user input is available for registration (step 320). For example, if the user input includes a requested domain name, alternatives generator 106 may communicate with registrar 102 and/or whois database 105 to determine if the requested domain name has already been registered. Similarly, if the user input includes a word or phrase, alternatives generator 106 may communicate with registrar 102 and/or whois database 105 to determine whether certain domain names including the word or phrase are available. For example, if the user input is “example,” alternatives generator 106 may determine whether the domain names example.com, example.net, and example.org are available.

If alternatives generator 106 determines that one or more domain names is available for registration (step 320, Y), alternatives generator 106 may notify the user of the availability and may facilitate registration of the domain name after having received the user's authorization (step 330).

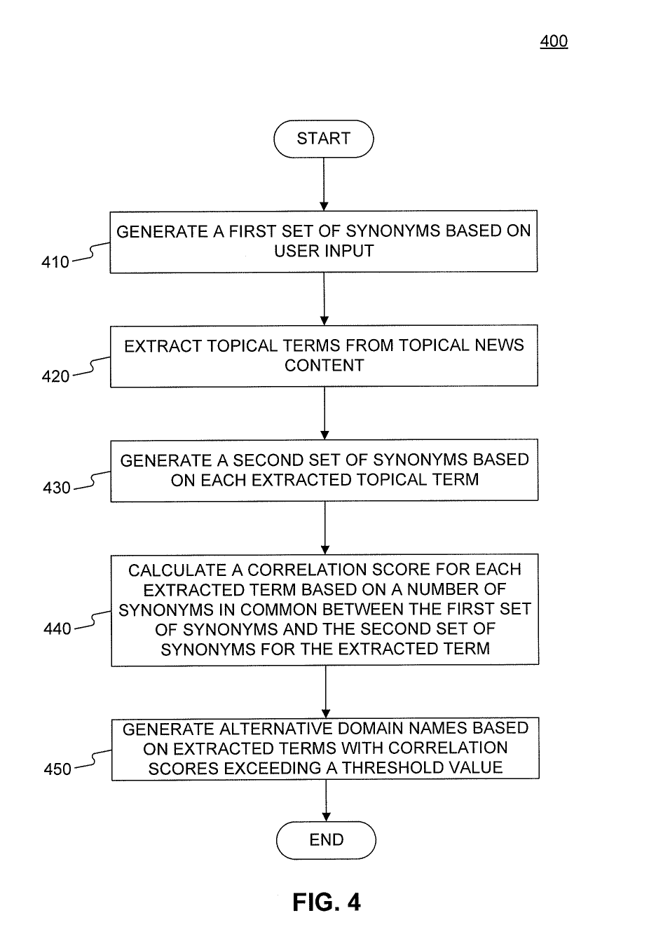

If, on the other hand, the domain name is not available for registration (step 320, N), alternatives generator 106 may generate alternative domain names based on the user input (step 340). In certain embodiments, alternatives generator 106 may generate the alternative domain names based on news content related to the user input. For example, alternatives generator 106 may correlate user input with popular terms in content from news sources on the Internet, as discussed above. In one embodiment, alternatives generator 106 may generate alternative domain names based on a correlation between the user input and synonyms of terms in news content, similar to process 400 disclosed in FIG. 4 and discussed in greater detail below.

Alternatives generator 106 may also determine the availability of the alternative domain names generated in step 340 (step 350). For example, alternatives generator 106 may communicate with registrar 102 and/or whois database 105 to determine if the requested domain name has already been registered.

Alternatives generator 106 may display one or more of the available alternative domain names to the user (step 360). In certain embodiments alternatives generator 106 may display all of the available alternative domain names to the user. In other embodiments, alternatives generator 106 may display only certain alternative domain names, such as those with the highest correlation to the user input. The correlation may be based on a correlation score, such as that calculated in accordance with process 400, discussed below.

Alternatives generator 106 may receive a selection from the user to register one or more of the displayed alternative domain names, and, via registry 101, may register the domain names based on the user's selection (step 370).

FIG. 4 is a flow diagram of a process 400 for generating alternative domain names and calculating correlation scores. Process 400 may be performed, for example, by alternatives generator 106. In certain embodiments, alternatives generator 106 may perform one or more steps of process 400 as part of process 300 for registering domain names. For example, alternatives generator 106 may perform process 400 when generating alternative domain names in step 340.

Alternatives generator 106 may generate a first set of synonyms based on the user input (step 410). For example, synonym module 204 may generate synonyms for one or more words in the user input, based on, e.g., a query to thesaurus database 205. If the user input includes multiple words or phrases, tokenization module 203 may tokenize the user input, e.g., break it into multiple words, and then synonym module 204 may generate synonyms for each tokenized part of the user input.

Alternatives generator 106 may extract terms from topical news content (step 420). For example, alternatives generator 106 may extract terms from topical news content stored in topical news content database 207. The topical terms may include, e.g., terms that commonly appear in news content for a topic related to one or more words in the user input.

Alternatives generator 106 may generate a second set of synonyms based on each extracted term from the topical news content (step 430). For example, synonym module 204 may generate synonyms for each extracted term, based on a query to thesaurus database 205.

Alternatives generator 106 may calculate a correlation score for each extracted topical term based on a number of synonyms in common between the first set of synonyms and the second set of synonyms for the extracted topical term (step 440). In certain embodiments, correlation module 206 may calculate a correlation score based on the popularity of the extracted topical term and/or its similarity to the user input.

Alternatives generator 106 may generate alternative domain names based on extracted terms with correlation scores exceeding a threshold value (step 450). For example, variants module 210 may generate variants based on the correlated extracted terms. Such variants may include, e.g., plurals, combinations, spelling variants, etc., of the user input, its synonyms and/or one or more of the extracted terms. Variants module 210 may also combine these variants with a Top Level Domain (.com, .net, .tv, .us, etc.) to create alternative domain names.

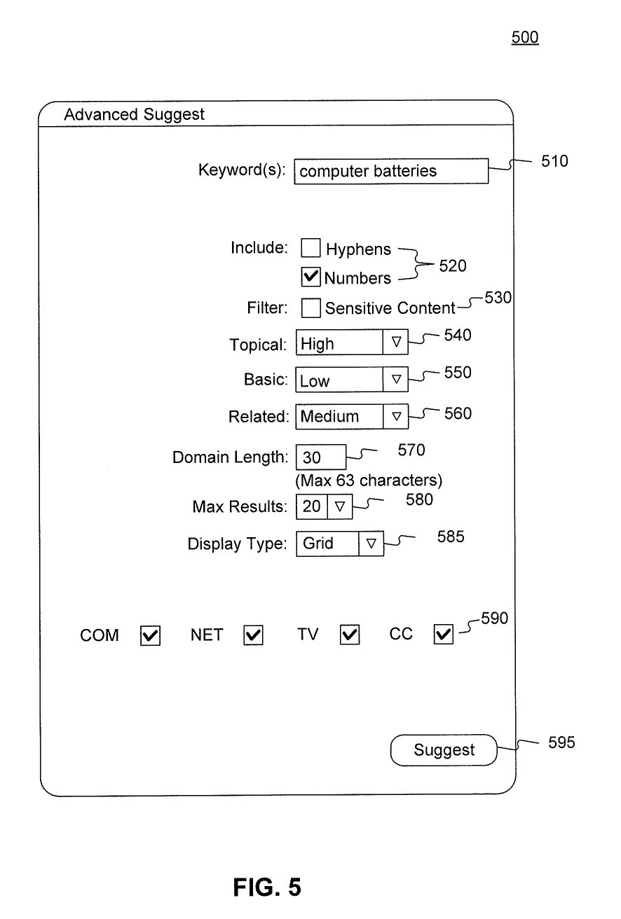

FIG. 5 is an exemplary interface 500 for a domain name generation system, consistent with certain disclosed embodiments. Interface 500 may be displayed at, e.g., user device 103, and may allow a user to enter user input regarding a requested domain name and/or a term or phrase provided by a user. For example, interface 500 may allow a user to enter one or more keywords in keyword field 510. A user may also enter the requested domain name in keyword field 510.

Interface 500 may also allow a user to filter the results received using one or more of the filters 520-590. For example, “Include” filters 520 allow a user to choose whether the generated alternative domain names will include hyphens or numbers. Similarly “Sensitive Content” filter 530 may allow a user to choose whether the generated alternative domain names will be filtered for sensitive content, including words that may be deemed inappropriate, words based on trademarked or otherwise protected words, etc. While filters 520 and 530 are shown as toggle buttons, any other selection interface may be used.

Filters 540-560 may allow a user to modify the criteria used by alternatives generator 106 to generation alternative domain names. For example, using “Topical” filter 540, a user may adjust the weight that alternatives generator 106 assigns to words found in the topical news source database. Similarly, using “Basic” filter 550, a user may adjust the weight that alternatives generator 106 assigns to words that are in the search entered by the user, such as the user input entered in keywords field 510. Using “Related” filter 560, a user may adjust the weight assigned to words that are related to the words entered as user input into keywords field 510, e.g., synonyms of the words. While filters 540-560 show drop-down menu boxes using “high,” “medium,” and “low” weightings, any other weighting system and interface may be used. For example, in one embodiment a user may be able to assign number weights to filters 540-560.

“Domain Length” filter 570 allows a user to specify the maximum length of the returned alternative domain names. For example, the user may include a limitation on the maximum number of characters such that if the user enters 30 into “Domain Length” filter 570, all of the results returned may have a length of 30 characters or fewer.

“Max Results” filter 580 allows a user to specify the maximum number of results that will be displayed. For example, if the user enters 20 into results filter 580, then no more than 20 results may be displayed to the user.

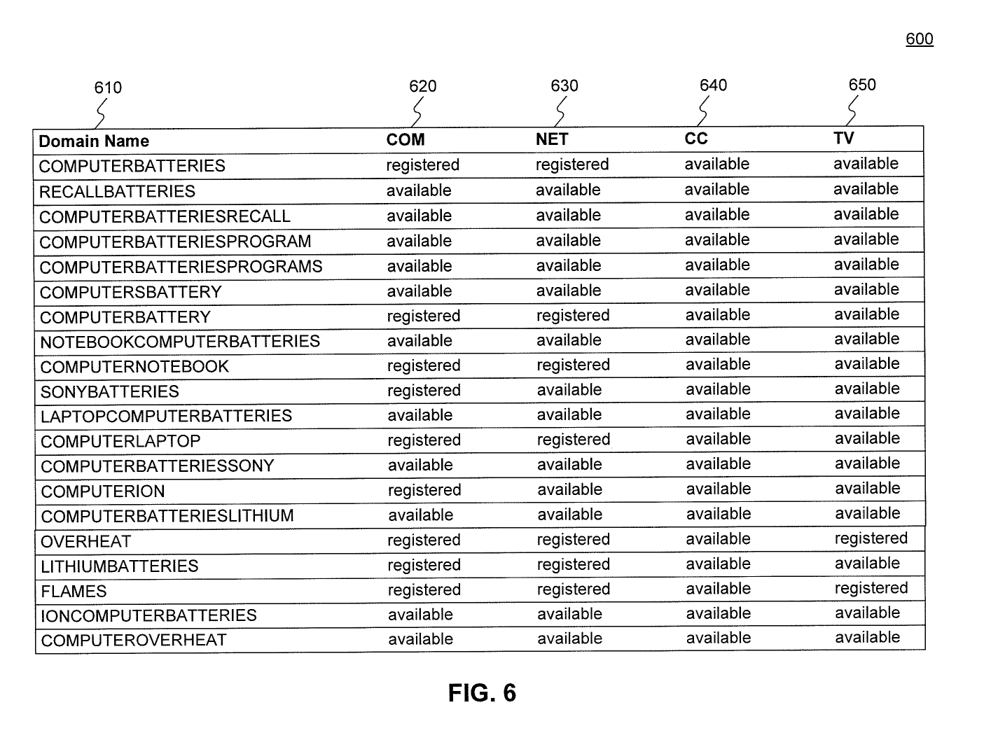

“Display Type” entry 585 allows the user to specify how the results will be displayed. For example, if the user selects a “grid” display, the results may be displayed as shown in FIG. 6, discussed below. However, in certain embodiments a user may be able to choose from other options, such as a “list” display, where the full domain names, including the top-level domain (TLD), such as “.com” or “.edu” are displayed to the user.

TLD filter 590 allows the user to choose which TLDs will be searched for availability when generating the alternative domain names. For example, if the user only selects “.com,” and “.net,” then alternatives may be generated and checked for availability for only those TLDs. While check boxes are used for TLD filter 590, any other interface may be used. For example, a user may enter the desired TLDs in a text box window, or may select the desired TLDs via a drop-down menu.

Once the user has entered the desired information into filters 520-590, the user may select suggest button 595. Selecting suggest button 595 may cause user device 103 to send the user input to alternatives generator 106, which may cause alternatives generator 106 to generate alternative domain names, as discussed above.

FIG. 6 is an exemplary interface 600 for a domain name generation system, consistent with certain disclosed embodiments. For example, interface 600 may be displayed on user device 103 based on output received from alternatives generator 106. Interface 600 may include a domain name list 610 that lists generated alternative domain names and displays them to the user.

Interface 600 may also include one or more TLD lists, such as .com list 620, .net list 630, .cc list 640, and .tv list 650. The TLD lists may be displayed in a grid, so that each row on a TLD list corresponds to the domain name that is in the same row in domain name list 610. The TLD lists may indicate to the user whether a domain is available or has already been registered. For example, the first row of interface 600 indicates that the domain name “computerbatteries” has already been registered in the .com and .net TLDs, but has not yet been registered in the .cc or .tv TLDs.

The foregoing descriptions have been presented for purposes of illustration and description. They are not exhaustive and do not limit the disclosed embodiments to the precise form disclosed. Modifications and variations are possible in light of the above teachings or may be acquired from practicing the disclosed embodiments. For example, the described implementation includes software, but the disclosed embodiments may be implemented as a combination of hardware and software or in firmware. Examples of hardware include computing or processing systems, including personal computers, servers, laptops, mainframes, micro-processors, and the like. Additionally, although disclosed aspects are described as being stored in a memory on a computer, one skilled in the art will appreciate that these aspects can also be stored on other types of computer-readable storage media, such as secondary storage devices, like hard disks, floppy disks, a CD-ROM, USB media, DVD, or other forms of RAM or ROM.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), XML, Java, C++, JavaScript, HTML, HTML/AJAX, Flex, Silverlight, or any other now known or later created programming language. One or more of such software sections or modules can be integrated into a computer system or existing browser software.

Other embodiments will be apparent to those skilled in the art from consideration of the specification and practice of the embodiments disclosed herein. The recitations in the claims are to be interpreted broadly based on the language employed in the claims and not limited to examples described in the present specification or during the prosecution of the application, which examples are to be construed non-exclusive. Further, the steps of the disclosed methods may be modified in any manner, including by reordering steps and/or inserting or deleting steps. It is intended, therefore, that the specification and examples be considered as exemplary only, with a true scope and spirit being indicated by the following claims and their full scope equivalents.

What is claimed is:

1. A system for determining alternative domain names comprising:
a receiver that receives user input;
a synonym module that determines synonyms of at least one word in the user input;
a correlation module that receives the synonyms from the synonym module and terms from a topical news source database and generates a correlation score for at least one of the terms from the topical news source database based on a correlation between the term from the topical news source database and the user input; and
a variants module that generates an alternative domain name based on the term or terms from the topical news source database and the associated correlation score or scores.

2. The system of claim 1, further comprising:
a tokenization module that receives the user input from the receiver, and if the user input includes more than one word, parses the user input into its constituent parts, wherein
the synonym module determines synonyms for one or more of the constituent parts.

3. The system of claim 1, further comprising a thesaurus database in communication with the synonym module, wherein the synonym module formulates and sends queries to the thesaurus database based upon the user input to the thesaurus database and receives synonyms in response.

4. The system of claim 1, wherein the correlation score generated by the correlation module for the term from the topical news source database is based at least in part on a popularity of the term from the topical news source.

5. The system of claim 4, wherein the variants module generates an alternative domain name based on the term from the topical news source database having a correlation score above a threshold.

6. The system of claim 4, wherein the popularity of the term from the topical news source database is based on the number of times the term occurs in a set of topical news content.

7. The system of claim 1, wherein the variants module combines at least two of the terms from the topical news source database to form an alternative domain name.

8. A computer-implemented method for determining alternative domain names comprising:
receiving user input;
extracting terms from topical news content;
determining a correlation score for an extracted term based on the similarity of the extracted term to the user input and the popularity of the extracted term in the topical news content; and
generating an alternative domain name based on the extracted term if the correlation score is above a threshold.

9. The method of claim 8, wherein the user input includes a group of words.

10. The method of claim 8, wherein the input from a user includes at least one of a group of words or a single compound word, the method further comprising:
tokenizing the group of words or the single compound word by parsing it into its constituent parts.

11. The method of claim 8, further comprising:
generating a first set of synonyms based on the extracted term;
generating a second set of synonyms based on the user input; and
determining the correlation score for the extracted term based on the number of synonyms that are common to both the first set of synonyms and the second set of synonyms.

12. The method of claim 8, further comprising generating an alternative domain name combining at least two of the extracted terms.

13. The method of claim 8, further comprising ranking the extracted terms based upon the price of each extracted term in an online advertisement sales system.

14. A computer-implemented method for determining alternative domain names, comprising:
receiving user input;
generating a plurality of alternative domain names based upon the user input, each alternative domain including a variant, synonym, combination of tokenized components, or a combination thereof of the user input;
assigning a rank to each generated alternative domain name based upon a correlation score of the alternative domain name, a price of the alternative domain name in an online advertisement sales system, or a combination thereof; and
providing at least one of the plurality of alternative domain names to a user.

15. The method of claim 14, wherein the user input includes a limitation on a maximum number of characters that may be included in any one of the plurality of alternative domain names.

16. The method of claim 15, further comprising:
determining that the desired domain name is not available to be registered, and
providing an indication that the desired domain name is not available to be registered.

17. The method of claim 14, further comprising:
determining, for each of the plurality of generated alternative domain names, whether the alternative domain name is available to be registered; and
providing the alternative domain name to the user along with an indication of whether the domain name is available to be registered.

18. The method of claim 14, further comprising providing to the user the rank of each domain name provided to the user.

19. The method of claim 14, further comprising:
receiving a request from the user to register at least one of the alternative domain names provided to the user; and
responsive to the request, registering the domain name.

20. A method comprising:
receiving a request to register a domain from a user, the request including a desired domain name term;
determining that the desired domain name is not available for registration;
generating a plurality of alternative domain names based on the desired domain name term and at least one of:
a term obtained from a topical news content source;
a tokenized component of a term obtained from a topical news content source;
a combination of tokenized components of a term obtained from a topical news content source and the desired domain name term;
or any combination thereof; and
presenting at least one of the plurality of alternative domain names to the user.
